(19) United States
(12) Patent Application Publication
(10) Pub. No.: US 2026/0178938 A1
(43) Pub. Date: Jun. 25, 2026

(54) INFORMATION PROCESSING APPARATUS, INFORMATION PROCESSING SYSTEM, INFORMATION PROCESSING METHOD, AND RECORDING MEDIUM

(71) Applicants: Masaki NOSE, Kanagawa (JP); Tetsuya TAKAHASHI, Kanagawa (JP); Tomokatsu EGAWA, Kanagawa (JP)

(72) Inventors: Masaki NOSE, Kanagawa (JP); Tetsuya TAKAHASHI, Kanagawa (JP); Tomokatsu EGAWA, Kanagawa (JP)

(21) Appl. No.: 19/372,286

(22) Filed: Oct. 29, 2025

(30) Foreign Application Priority Data
Dec. 19, 2024 (JP) 2024-224071

(51) Int. Cl. G06N 5/022

(52) U.S. Cl. CPC G06N 5/022

(57) ABSTRACT

An information processing apparatus includes circuitry and a memory. The circuitry sets a first interactive artificial intelligence (AI) that interacts with a user via a user terminal. The memory stores an action history of the user who interacts with the first interactive AI. Based on the action history of the user, the circuitry determines whether to switch from the first interactive AI to a second interactive AI different from the first interactive AI during an interaction between the first interactive AI and the user, and switches from the first interactive AI to the second interactive AI based on a result of the determination.

### CROSS-REFERENCE TO RELATED APPLICATIONS

This patent application is based on and claims priority pursuant to 35 U.S.C. § 119(a) to Japanese Patent Application No. 2024-224071, filed on Dec. 19, 2024, in the Japan Patent Office, the entire disclosure of which is hereby incorporated by reference herein.

### BACKGROUND

### Technical Field

Embodiments of the present disclosure relate to an information processing apparatus, an information processing system, an information processing method, and a recording medium.

### Related Art

There is an information processing apparatus that provides a plurality of conversational artificial intelligences (AIs) that converses with a user via a user terminal. For example, a technique is known that selects and provides a conversational AI suitable for the user based on the dialogue analysis and information input from the user. Examples of the information input from the user include auditory information, textual information, and visual information, in addition to the name of the user.

### SUMMARY

The present disclosure described herein provides an information processing apparatus including circuitry and a memory. The circuitry sets a first interactive artificial intelligence (AI) that interacts with a user via a user terminal. The memory stores an action history of the user who interacts with the first interactive AI. Based on the action history of the user, the circuitry determines whether to switch from the first interactive AI to a second interactive AI different from the first interactive AI during an interaction between the first interactive AI and the user, and switches from the first interactive AI to the second interactive AI based on a result of the determination.

The present disclosure described herein provides an information processing system including the above-described information processing apparatus and a user terminal to communicate with the information processing apparatus. The user terminal includes a display that displays the first interactive AI or the second interactive AI.

The present disclosure described herein provides an information processing method including setting a first interactive artificial intelligence (AI) that interacts with a user via a user terminal, storing an action history of the user who interacts with the first interactive AI, based on the action history of the user, determining whether to switch from the first interactive AI to a second interactive AI different from the first interactive AI during an interaction between the first interactive AI and the user, and switching from the first interactive AI to the second interactive AI based on a result of the determining.

The present disclosure described herein provides a non-transitory recording medium storing a plurality of instructions which, when executed by one or more processors, causes the one or more processors to perform an information processing method. The information processing method includes setting a first interactive artificial intelligence (AI) that interacts with a user via a user terminal, storing an action history of the user who interacts with the first interactive AI, based on the action history of the user, determining whether to switch from the first interactive AI to a second interactive AI different from the first interactive AI during an interaction between the first interactive AI and the user, and switching from the first interactive AI to the second interactive AI based on a result of the determining.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example system configuration of an information processing system;

FIG. 2 is a diagram illustrating another example system configuration of the information processing system;

FIG. 3 is a diagram illustrating an example hardware configuration of a computer;

FIG. 4 is a diagram illustrating an example hardware configuration of an information terminal;

FIG. 5 is a diagram illustrating an example functional configuration of the information processing system;

FIG. 6 is a diagram illustrating an example functional configuration of a switching control unit;

FIG. 7 is a sequence diagram illustrating an example of a conversational artificial intelligence (AI) switching process according to a first embodiment;

FIG. 8 is a flowchart illustrating an example of a conversational AI setting process according to the first embodiment;

FIG. 9 is a flowchart illustrating an example of a process of determining whether to switch conversational AIs according to the first embodiment;

FIG. 10 is a sequence diagram illustrating an example of a conversational AI switching process according to a second embodiment;

FIG. 11 is a flowchart illustrating an example of a process of determining whether to switch conversational AIs according to the second embodiment;

FIGS. 12A and 12B (FIG. 12) are tables illustrating example switching information;

FIG. 13 is a view of an example display screen;

FIG. 14 is another view of the example display screen; and

FIG. 15 is a flowchart illustrating an example of a process performed by an information processing apparatus according to a third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### System Configuration

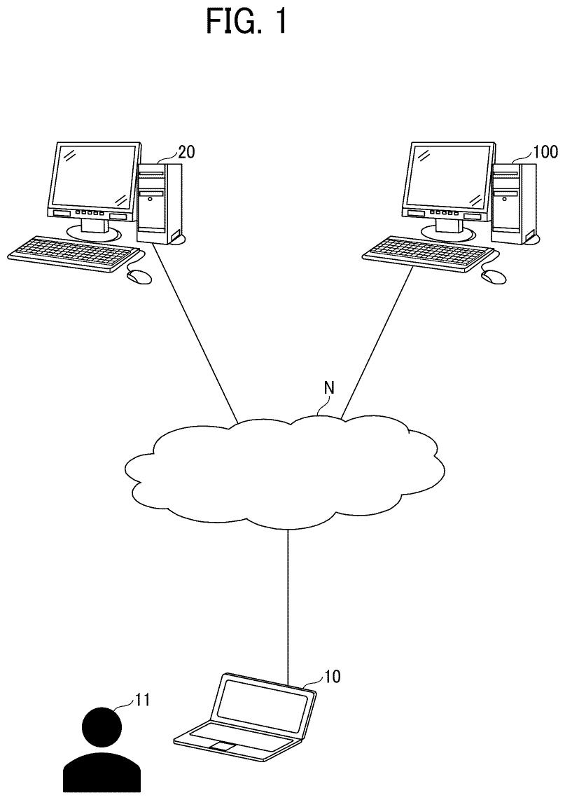

FIG. 1 is a diagram illustrating an example system configuration of an information processing system 1. In the example illustrated in FIG. 1, the information processing system 1 includes a user terminal 10, a host server 20, and an information processing apparatus 100, which are connected to a communication network N including, for example, the Internet and a local area network (LAN).

The user terminal 10 is an information terminal used by a user 11. Examples of the user terminal 10 include a personal computer (PC), a tablet terminal, and a smartphone. The user terminal 10 is communicable with the host server 20 and the information processing apparatus 100 via the communication network N. The user 11 uses a service provided by the host server 20 to interact with an interactive artificial intelligence (AI) provided by the information processing apparatus 100. In this disclosure, the case where the interactive AI is a conversational AI, which simulates human-like conversations using text or voice, is described. However, the interaction with the user may include gestures, facial expressions, or any other forms of interaction.

The host server 20 is, for example, an information processing apparatus implemented by a computer or a system including a plurality of computers. The computer implementing the host server 20 may be, for example, a virtual machine on a cloud. The host server 20 is, for example, a system that provides a metaverse, which is a virtual space on the Internet, or a system that provides a service such as web conferencing. In one or more embodiments of the present disclosure, the host server 20 may have any configuration. For example, the host server 20 may be a general-purpose system that provides a service outside the information processing system 1.

The information processing apparatus 100 is an information processing apparatus implemented by a computer or a system including a plurality of computers. The computer implementing the information processing apparatus 100 may be, for example, a virtual machine on a cloud. The information processing apparatus 100 provides, for example, a plurality of conversational AIs that converses with the user 11 via the user terminal 10.

A conversational AI is a program or a system that responds to an inquiry from the user 11 using the user terminal 10. For example, the conversational AI, which is also referred to as an AI agent or a conversational agent, is a service that automatically responds using AI, a chatbot, or a knowledge base including registered information and knowledge. Preferably, the information processing apparatus 100 supports the execution of a predetermined task such as a business negotiation or nursing care through a dialogue in which the conversational AI automatically responds to a voice or a message from the user 11.

In one example use case, the conversational AI may be used as an unmanned AI avatar in a web conference, a website, a smartphone application, or a metaverse virtual space (hereinafter referred to as “metaverse space”). The information processing apparatus 100 may change a dialogue scenario to adapt the contents of the dialogue to various applications such as business negotiation, nursing care, a lecture, and counseling.

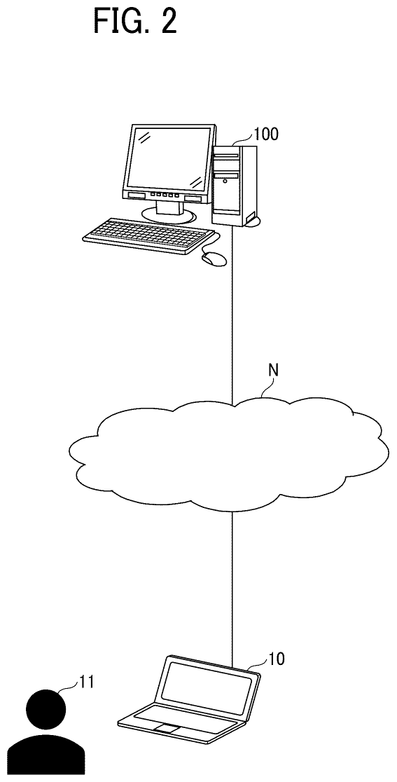

FIG. 2 is a diagram illustrating another example system configuration of the information processing system 1. In the example illustrated in FIG. 2, the information processing system 1 includes the user terminal 10 and the information processing apparatus 100, which are connected to the communication network N. As in this example, the information processing system 1 may not include the host server 20.

In this case, the information processing apparatus 100 may have the function of the host server 20 described with reference to FIG. 1 or provide a plurality of conversational AIs, which converses with the user 11, to the user terminal 10 without using the function of the host server 20.

The information processing apparatus 100 according to one or more embodiments of the present disclosure provides a plurality of conversational AIs that converses with the user 11 via the user terminal 10, and has a function of selecting an appropriate conversational AI or switching conversational AIs based on the information input by the user 11 or the action history of the user 11. Accordingly, the information processing apparatus 100 ensures the improved user experience and provides a more effective dialogue using the expertise of each conversational AI.

### Hardware Configurations

### Hardware Configuration of Computer

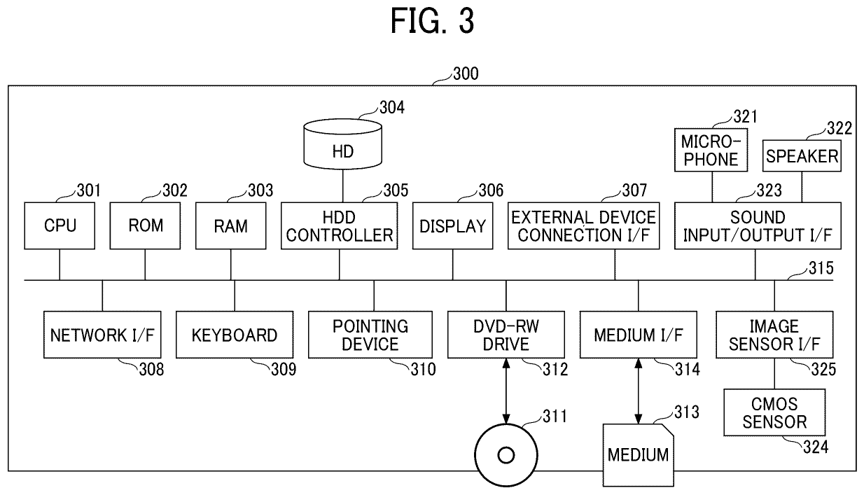

The host server 20 and the information processing apparatus 100 have, for example, a hardware configuration of a computer 300 as illustrated in FIG. 3. The host server 20 or the information processing apparatus 100 may include a plurality of computers 300.

The user terminal 10 may have, for example, the hardware configuration of the computer 300 as illustrated in FIG. 3.

FIG. 3 is a diagram illustrating the example hardware configuration of the computer 300. As illustrated in FIG. 3, the computer 300 includes, for example, a central processing unit (CPU) 301, a read-only memory (ROM) 302, a random-access memory (RAM) 303, a hard disk (HD) 304, a hard disk drive (HDD) controller 305, a display 306, an external device connection interface (I/F) 307, a network I/F 308, a keyboard 309, a pointing device 310, a digital versatile disk-rewritable (DVD-RW) drive 312, a medium I/F 314, and a bus line 315.

In a case where the user terminal 10 includes the computer 300, the computer 300 further includes a microphone 321, a speaker 322, a sound input/output I/F 323, a complementary metal-oxide semiconductor (CMOS) sensor 324, and an image sensor I/F 325.

The CPU 301 controls the operation of the computer 300. The ROM 302 stores, for example, programs such as an initial program loader (IPL) for executing the computer 300. The RAM 303 is, for example, used as a work area for the CPU 301. The HD 304 stores, for example, various data and programs such as an operating system (OS), an application, and a device driver. The HDD controller 305 controls, for example, the reading and writing of various data from and to the HD 304 under the control of the CPU 301. The HD 304 and the HDD controller 305 are examples of a storage device.

The display 306 displays, for example, various types of information such as a cursor, menus, windows, characters, and images. The display 306 may be disposed outside the computer 300. The external device connection I/F 307 is an interface for connecting various external devices to the computer 300. The network I/F 308 is an interface for connecting the computer 300 to the communication network N to communicate with other apparatuses via the communication network N.

The keyboard 309 is an example of an input device including a plurality of keys for inputting, for example, characters, numerical values, and various instructions. The pointing device 310 is an example of an input device that allows a user to select or execute various instructions, select a target to be processed, and move a cursor being displayed. The keyboard 309 and the pointing device 310 may be disposed outside the computer 300.

The DVD-RW drive 312 controls the reading and writing of various data from and to a DVD-RW 311, which is an example of a removable recording medium. The DVD-RW 311 is not limited to a DVD-RW and may be another removable recording medium. The medium I/F 314 controls the reading and writing (storing) of data from and to a medium 313 such as a flash memory. The bus line 315 includes, for example, an address bus, a data bus, and various control signals for electrically connecting the above-described components to each other.

The microphone 321 is a built-in circuit that converts sound into an electrical signal. The speaker 322 is a built-in circuit that converts an electrical signal into physical vibration to generate sound such as music or audio. The sound input/output I/F 323 is a circuit that controls the input and output of a sound-wave signal between the microphone 321 and the speaker 322 under the control of the CPU 301.

The CMOS sensor 324 is an example of a built-in imaging device that captures an image of a subject (e.g., a self-portrait image) and obtains image data under the control of the CPU 301. The computer 300 may include another imaging device such as a charge-coupled device (CCD) sensor, instead of the CMOS sensor 324. The image sensor I/F 325 is a circuit that controls the driving of the CMOS sensor 324.

### Hardware Configuration of Information Terminal

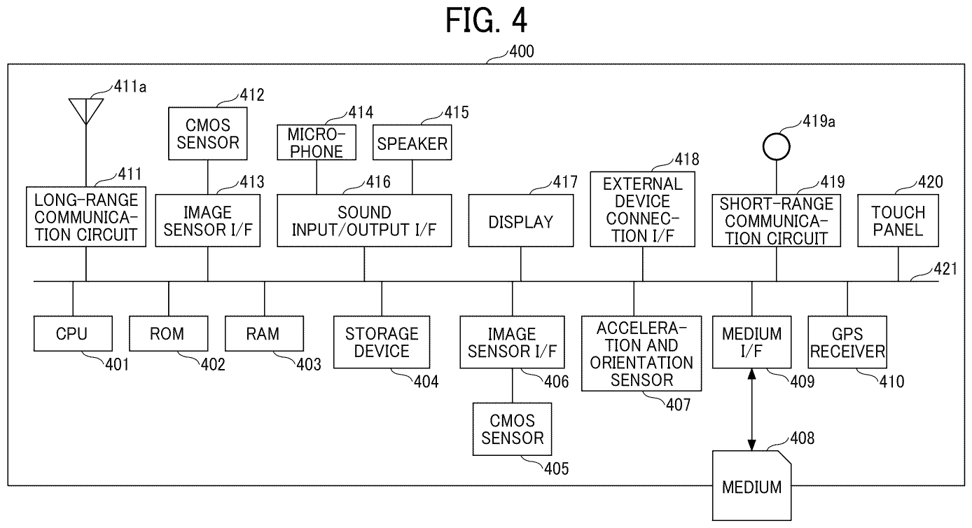

FIG. 4 is a diagram illustrating an example hardware configuration of an information terminal 400. The user terminal 10 has, for example, the hardware configuration of the information terminal 400 as illustrated in FIG. 4. As described above, the user terminal 10 may have the hardware configuration of the computer 300 as illustrated in FIG. 3.

In the example illustrated in FIG. 4, the information terminal 400 includes a CPU 401, a ROM 402, a RAM 403, a storage device 404, a CMOS sensor 405, an image sensor I/F 406, an acceleration and orientation sensor 407, a medium I/F 409, and a global positioning system (GPS) receiver 410.

The CPU 401 executes a predetermined program to control the operation of the information terminal 400. The ROM 402 stores, for example, programs such as an IPL for executing the CPU 401. The RAM 403 is, for example, used as a work area for the CPU 401. The storage device 404 is a large-capacity storage device that stores various data and programs such as an OS and an application. For example, the storage device 404 may include a solid-state drive (SSD) or a flash ROM.

The CMOS sensor 405 is an example of a built-in imaging device that captures an image of a subject (mainly a self-portrait image) and obtains image data under the control of the CPU 401. The user terminal 10 may include another imaging device such as a CCD sensor, instead of the CMOS sensor 405. The image sensor I/F 406 is a circuit that controls the driving of the CMOS sensor 405. The acceleration and orientation sensor 407 includes various sensors such as an electromagnetic compass that detects geomagnetism, a gyrocompass, and an acceleration sensor. The medium I/F 409 controls the reading and writing (storing) of data from and to a medium (recording medium) 408 such as a flash memory. The GPS receiver 410 receives a GPS signal (positioning signal) from a GPS satellite.

The information terminal 400 also includes a long-range communication circuit 411, an antenna 411a of the long-range communication circuit 411, a CMOS sensor 412, an image sensor I/F 413, a microphone 414, a speaker 415, a sound input/output I/F 416, a display 417, an external device connection I/F 418, a short-range communication circuit 419, an antenna 419a of the short-range communication circuit 419, and a touch panel 420.

The long-range communication circuit 411 is, for example, a circuit that communicates with other apparatuses through the communication network N. The CMOS sensor 412 is an example of a built-in imaging device that captures an image of a subject and obtains image data under the control of the CPU 401. The image sensor I/F 413 is a circuit that controls the driving of the CMOS sensor 412. The microphone 414 is a built-in circuit that converts sound into an electrical signal. The speaker 415 is a built-in circuit that converts an electrical signal into physical vibration to generate sound such as music or voice. The sound input/output I/F 416 is a circuit that controls the input and output of a sound-wave signal between the microphone 414 and the speaker 415 under the control of the CPU 401.

The display 417 is an example of a display device such as a liquid-crystal display device or an organic electro-luminescence (EL) display device that displays, for example, an image of a subject and various icons. The external device connection I/F 418 is an interface for connecting various external devices to the information terminal 400. The short-range communication circuit 419 includes a circuit that performs short-range wireless communication. The touch panel 420 is an example of an input device that allows the user 11 to operate the user terminal 10 by touching the display 417.

The user terminal 10 includes a bus line 421. The bus line 421 includes, for example, an address bus and a data bus for electrically connecting the above-described components such as the CPU 401 illustrated in FIG. 4 to each other.

### Functional Configuration

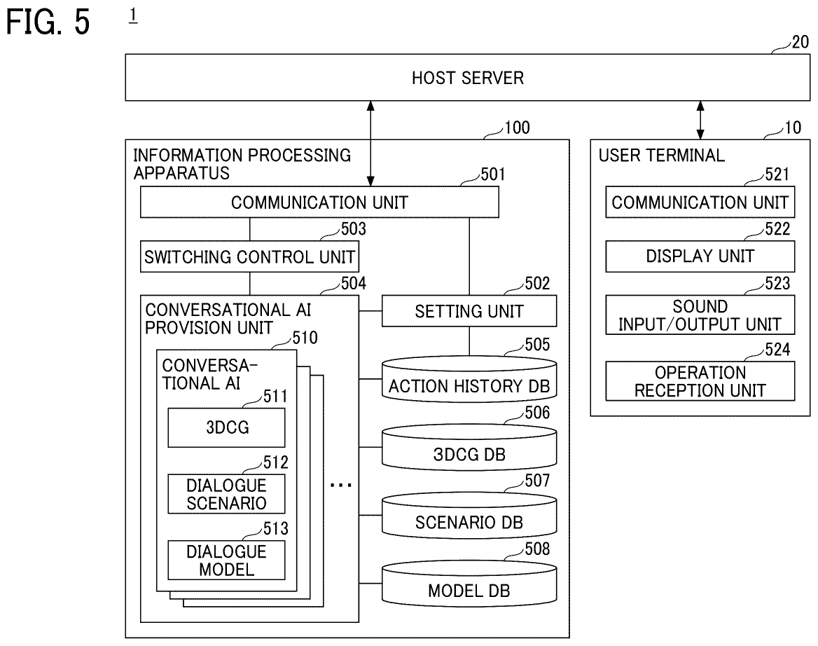

FIG. 5 is a diagram illustrating an example functional configuration of the information processing system 1.

### Functional Configuration of Information Processing Apparatus

The information processing apparatus 100 implements, for example, functional units illustrated in FIG. 5 by the computer 300, which is included in the information processing apparatus 100, executing a predetermined program stored in a storage medium. In the example illustrated in FIG. 5, the information processing apparatus 100 includes functional units such as a communication unit 501, a setting unit 502, a switching control unit 503, a conversational AI provision unit 504, an action history database (DB) 505, a three-dimensional computer graphics (3DCG) DB 506, a scenario DB 507, and a model DB 508. The databases such as the action history DB 505, the 3DCG DB 506, the scenario DB 507, and the model DB 508 may be external databases disposed outside the information processing apparatus 100.

The communication unit 501 performs a communication process to connect the information processing apparatus 100 to the communication network N using, for example, the network I/F 308 and communicate with the host server 20 or the user terminal 10. For example, the communication unit 501 receives predetermined information of the user 11 using the user terminal 10.

Preferably, the predetermined information includes information relating to the action history of the user 11. The information relating to the action history of the user 11 includes recorded information relating to a predetermined action performed by the user 11. The predetermined action includes, for example, one or more pieces of information among a movement history, a browsing history, a search history, a selection history, a purchase history, and an interaction history such as a dialogue history. Preferably, the information relating to the action history of the user 11 includes one or more pieces of information among position information, device information, contents of information input in a form, an activity in social media, and an application in use.

These pieces of information may be, for example, received from the host server 20 or the user terminal 10.

The setting unit 502 performs a setting process to set a first conversational AI, which converses with the user 11, based on the action history of the user 11 stored in a DB such as the action history DB 505. For example, in a case where there is an action history indicating that the user 11 has conversed with a conversational AI, the setting unit 502 sets the conversational AI that has conversed with the user 11 in the past (e.g., the conversational AI that conversed with the user 11 last time) as the first conversational AI, which converses with the user 11 this time.

In a case where the action history of the user 11 is not available, the setting unit 502 sets the first conversational AI based on attribute information of the user 11. Examples of the attribute information include the name, age, gender, and address of the user 11 and the industry in which the user 11 works.

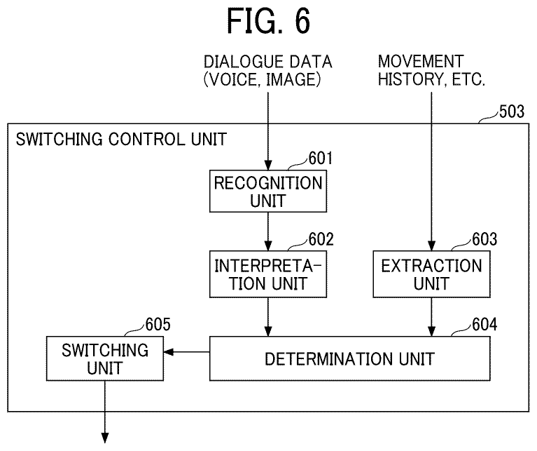

The switching control unit 503 performs a switching control process to switch from the first conversational AI, which converses with the user 11, to a second conversational AI, which is different from the first conversational AI, based on the predetermined information of the user 11. The switching control unit 503 includes, for example, functional units as illustrated in FIG. 6. In the example illustrated in FIG. 6, the switching control unit 503 includes functional units such as a recognition unit 601, an interpretation unit 602, an extraction unit 603, a determination unit 604, and a switching unit 605.

The recognition unit 601 performs a recognition process to recognize dialogue data of the user 11. For example, the recognition unit 601 performs a speech recognition process on the voice included in the dialogue data to convert speech of the user 11 into text. Preferably, the recognition unit 601 further acquires non-verbal information of the user 11, such as the volume, intonation, or tone of the voice of the user 11, from the dialogue data (voice and image) of the user 11.

The interpretation unit 602 performs an intent interpretation process to interpret the intent of the speech of the user 11 based on, for example, the verbal information of the user 11 recognized by the recognition unit 601. Preferably, the interpretation unit 602 interprets the intent of the speech of the user 11, taking into account the non-verbal information of the user 11 recognized by the recognition unit 601.

For example, a machine learning model may be trained in advance using a plurality of pieces of verbal information and non-verbal information of a plurality of users as input data to interpret the intent of the speech of a user. Then, the interpretation unit 602 may input verbal information and non-verbal information of the user 11 into the trained machine learning model to interpret the intent of the speech of the user 11.

Machine learning herein refers to a technique that enables a computer to acquire a human-like learning ability. Specifically, machine learning refers to a technique that enables a computer to autonomously generate an algorithm to be used for determination, such as data identification, from training data input to the computer in advance and apply the generated algorithm to new data to make a prediction. Machine learning may employ any learning method such as supervised learning, unsupervised learning, semi-supervised learning, reinforcement learning, deep learning, or any combination of these learning methods.

The extraction unit 603 performs an extraction process to extract information for determining whether to switch conversational AIs based on the predetermined information of the user 11 received by the communication unit 501. For example, the extraction unit 603 extracts (identifies) the type of content that the user 11 is interested in from the predetermined information of the user 11.

Preferably, the extraction unit 603 extracts information for determining whether to switch conversational AIs based on the predetermined information acquired after the setting unit 502 sets the first conversational AI, which converses with the user 11.

The determination unit 604 performs a determination process to determine whether to switch conversational AIs that converse with the user 11 based on, for example, the intent of the speech of the user 11 interpreted by the interpretation unit 602 or the type of content extracted by the extraction unit 603 that the user 11 is interested in. For example, the determination unit 604 determines whether to switch from the first conversational AI set by the setting unit 502 to the second conversational AI different from the first conversational AI based on the action history of the user 11 during a dialogue between the user 11 and the first conversational AI.

Preferably, the determination unit 604 implements an algorithm for analyzing the dialogue history of the user 11 and the current context and selecting an appropriate conversational AI.

The switching unit 605 performs a switching process to switch the conversational AI that conducts the dialogue from the first conversational AI to the second conversational AI based on the result of the determination of the determination unit 604. For example, the switching unit 605 switches the conversational AIs smoothly so that the user 11 perceives no interruption of the dialog. When switching conversational AIs, the switching unit 605 takes over, for example, dialogue history information or the intent of the user 11. Further, when switching conversational AIs, the switching unit 605 may selectably present the user 11 with one or more candidate conversational AIs as switching candidates and switch from the current conversational AI to the conversational AI selected by the user 11.

Referring back to FIG. 5, the conversational AI provision unit 504 of the information processing apparatus 100 performs a conversational AI provision process to provide a plurality of conversational AIs 510.

A conversational AI 510 is a service that automatically responds to an inquiry from the user 11 using the user terminal 10, by using, for example, AI, a chatbot, or a knowledge base including registered information and knowledge. The conversational AI 510 includes, for example, a 3DCG 511, a dialogue scenario 512, and a dialogue model 513.

The 3DCG 511 is a three-dimensional computer graphics (CG) that displays the conversational AI 510 (e.g., a synthesized human image) on the user terminal 10. The CG that displays the conversational AI 510 is not limited to a three-dimensional CG and may also be a two-dimensional CG. The dialogue scenario 512 is pre-set data that defines a flow or pattern of a dialogue between the conversational AI 510 and the user 11. The dialogue model 513 is a trained dialogue model (machine learning model) that converses with the user 11.

The conversational AI provision unit 504 provides a plurality of conversational AIs 510, each of which is a combination of the 3 DCG 511, which is registered in the 3DCG DB 506, the dialogue scenario 512, which is registered in the scenario DB 507, and the dialogue model 513, which is registered in the model DB 508.

The action history DB (storage unit) 505 is, for example, a database in which the action history (e.g., a dialogue history, a visit history, etc.) of the user 11 is registered. The action history DB 505 is an example of a storage unit that stores the action history of the user 11 who converses with the first conversational AI. The 3DCG DB 506 is a database in which a plurality of 3 DCGs 511 is registered. The scenario DB 507 is a database in which a plurality of dialogue scenarios 512 is registered. The model DB 508 is a database in which a plurality of dialogue models 513 is registered. Hereinafter, the 3DCG DB 506, the scenario DB 507, and the model DB 508 may be collectively referred to as a conversational AI DB.

### Functional Configuration of User Terminal

The user terminal 10, which has the hardware configuration of the information terminal 400 as illustrated in FIG. 4, has a functional configuration as illustrated in FIG. 5. The user terminal 10 may have the hardware configuration of the computer 300 as illustrated in FIG. 3, for example.

The user terminal 10 implements, for example, functional units illustrated in FIG. 5 by the CPU 401 executing a predetermined program stored in a storage medium such as the storage device 404. In the example illustrated in FIG. 5, the user terminal 10 includes functional units such as a communication unit 521, a display unit 522, a sound input/output unit 523, and an operation reception unit 524. At least part of the above-described functional units may be implemented by hardware.

The communication unit 521 performs a communication process to connect the user terminal 10 to the communication network N using, for example, the long-range communication circuit 411 and communicate with the host server 20 or the information processing apparatus 100. The display unit 522 performs a display process to display the conversational AI provided by the information processing apparatus 100 using, for example, the display 417. The sound input/output unit 523 performs a sound input/output process to input a voice of the user 11 and output an audio of the conversational AI using, for example, the microphone 414, the speaker 415, and the sound input/output I/F 416. The operation reception unit 524 performs an operation reception process to receive an operation from the user 11.

### Functional Configuration of Host Server

In one or more embodiments of the present disclosure, the host server 20 may be a metaverse system, a web conferencing system, or any other system or apparatus that allows the conversational AI 510 provided by the information processing apparatus 100 and the user 11 to converse with each other via the user terminal 10. Therefore, the functional configuration of the host server 20 is not elaborated herein.

### Processing Flow

A process flow of an information processing method according to a first embodiment is described below.

### First Embodiment

### Conversational AI Switching Process

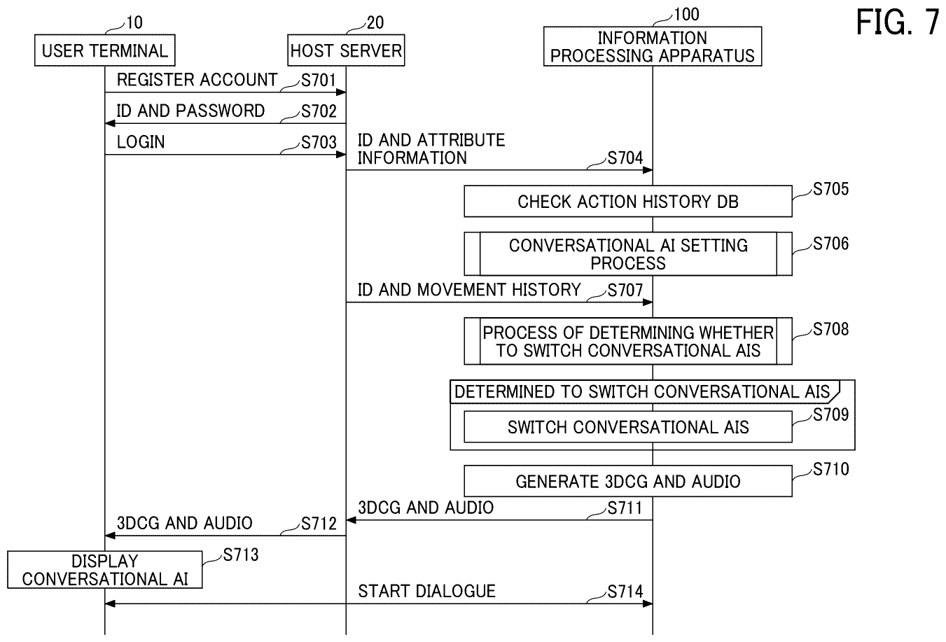

FIG. 7 is a sequence diagram illustrating an example of a conversational AI switching process according to the first embodiment. As an example, it is assumed that the user 11 views content exhibited at a trade show in a metaverse space presenting business improvement solutions.

In step S701, the user 11 accesses an entry site of the metaverse trade show provided by the host server 20 using the user terminal 10 and registers an account in the host server 20. Specifically, the user 11 registers attribute information in the host server 20. Examples of the attribute information include the name, age, gender, and address of the user 11 and the industry in which the user 11 works.

In step S702, the host server 20 issues login information (ID and password) for logging into the metaverse trade show to the user terminal 10 used by the user 11 who has registered the account.

In step S703, the user 11 logs into the metaverse trade show provided by the host server 20 on the user terminal 10.

In step S704, the host server 20 transmits the ID for identifying the user 11 who has logged in and the attribute information registered by the user 11 to the information processing apparatus 100.

In step S705, the setting unit 502 of the information processing apparatus 100 checks the action history DB 505 using the ID received from the host server 20 to determine whether there is any conversational AI 510 that has conversed with the user 11 in the past.

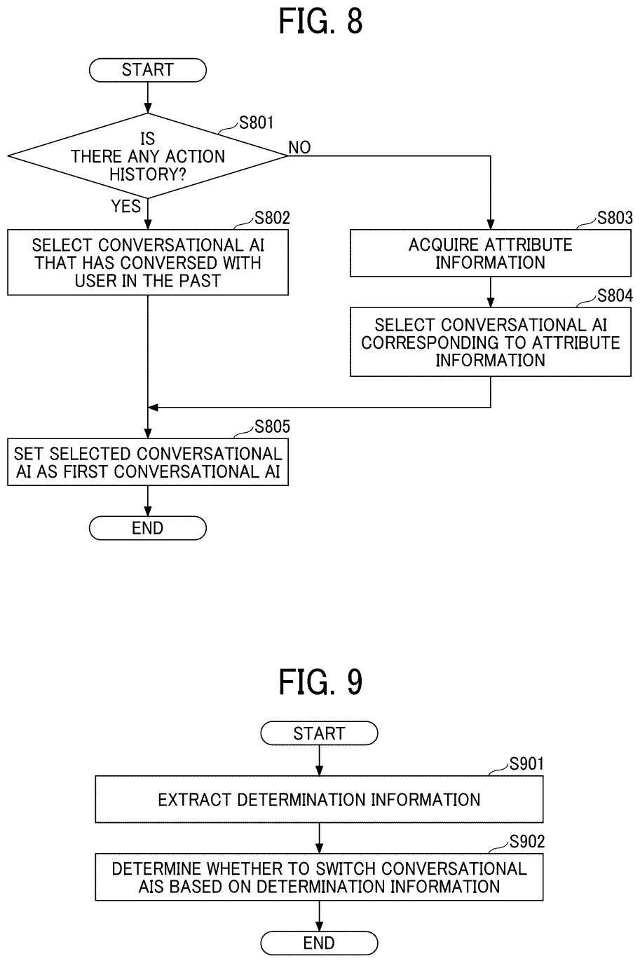

In step S706, the setting unit 502 performs a conversational AI setting process as illustrated in FIG. 8, for example.

FIG. 8 is a flowchart illustrating an example of the conversational AI setting process according to the first embodiment. This process is, for example, an example of the conversational AI setting process performed by the setting unit 502 of the information processing apparatus 100 in step S706 of FIG. 7.

In step S801, the setting unit 502 determines whether there is any action history corresponding to the ID of user 11. For example, the setting unit 502 checks the action history DB 505. In a case where there is any conversational AI 510 that has conversed with the user 11 in the past, the setting unit 502 determines that the action history corresponding to the ID of the user 11 is available. In a case where the action history corresponding to the ID of the user 11 is available, the setting unit 502 causes the processing to proceed to step S802. In a case where the action history corresponding to the ID of the user 11 is not available, the setting unit 502 causes the processing to proceed to step S803.

In step S802, the setting unit 502 selects a conversational AI 510 that has conversed with the user 11 in the past. For example, the setting unit 502 selects the conversational AI 510 that conversed with the user 11 last time.

In step S803, the setting unit 502 acquires the attribute information of the user 11 received from the host server 20 in step S704 of FIG. 7.

In step S804, the setting unit 502 selects a conversational AI 510 corresponding to the attribute information. For example, in a case where the user 11 works in a manufacturing industry, the setting unit 502 selects a conversational AI 510 that introduces a product relating to production management solutions from among various conversational AIs 510 that have been pre-registered in the conversational AI DB. In a case where the attribute information (e.g., information regarding the industry in which the user 11 works) alone is not sufficient to accurately predict which product the user 11 may be interested in, the setting unit 502 may, for example, select a conversational AI 510 that comprehensively introduces all product offerings.

In step S805, the setting unit 502 sets the selected conversational AI as the first conversational AI corresponding to user 11.

Referring back to FIG. 7, the extraction unit 603 of the information processing apparatus 100 acquires, for example, the movement history corresponding to the ID of the user 11 from the host server 20 in step S707. For example, the extraction unit 603 acquires the action history in the metaverse virtual space corresponding to the ID of the user 11 who has logged in. This action history includes, for example, the type of content viewed by the user 11 and the viewing time of the content (e.g., the user has viewed content relating to component management software for 15 minutes and content relating to production management software for 2 minutes). The action history also includes, for example, the type of exhibition booth visited by the user 11 and the number of visits to this type of exhibition booth.

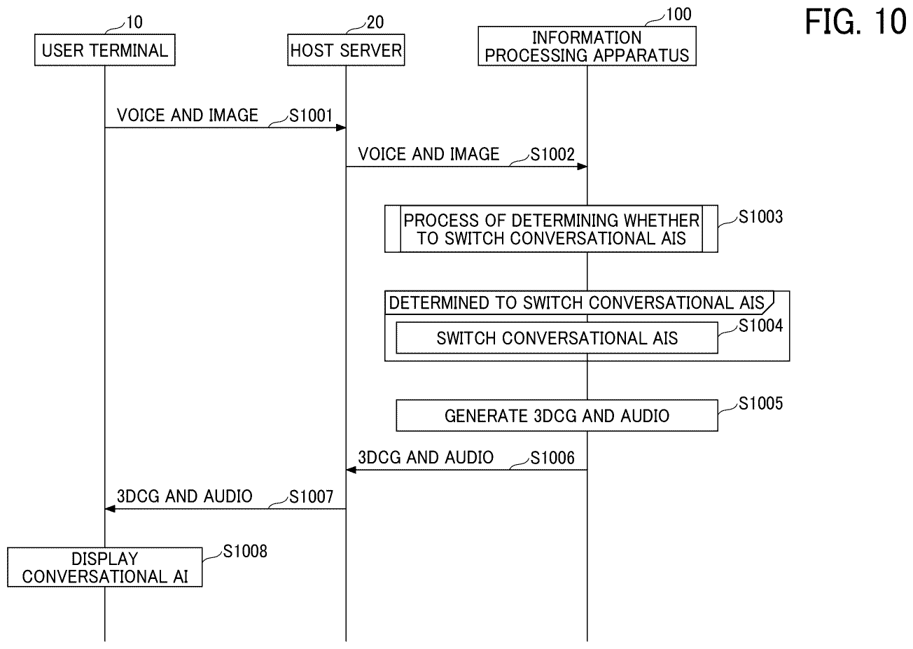

In step S708, the information processing apparatus 100 performs, for example, a process of determining whether to switch the conversational AIs 510, as illustrated in FIG. 9.

FIG. 9 is a flowchart illustrating an example of the process of determining whether to switch the conversational AIs 510 according to the first embodiment. This process is an example of the process performed by the information processing apparatus 100 in step S708 of FIG. 7 to determine whether to switch the conversational AIs 510.

In step S901, the extraction unit 603 extracts determination information for determining whether to switch the conversational AIs 510 from the acquired movement history, etc. For example, the extraction unit 603 extracts (identifies) the type of content that the user 11 is most interested in from, for example, the type of content viewed by the user 11 for the longest duration and the type of industry of the exhibition booth most frequently visited by the user 11 to determine whether to switch from the first conversational AI set by the setting unit 502 to a different conversational AI.

In step S902, the determination unit 604 determines whether to switch the conversational AIs 510 based on the determination information extracted by the extraction unit 603. For example, the determination unit 604 extracts, from the conversational AI DB (including the 3DCG DB 506, the scenario DB 507, and the model DB 508), a conversational AI 510 corresponding to the user 11's most interested type of content extracted by the extraction unit 603. In a case where the extracted conversational AI 510 (the second conversational AI) is not the same as the conversational AI 510 (the first conversational AI) set by the setting unit 502, the determination unit 604 determines to switch from the first conversational AI to the second conversational AI. In a case where the extracted conversational AI 510 (the second conversational AI) is the same as the conversational AI 510 (the first conversational AI) set by the setting unit 502, the determination unit 604 determines not to switch from the first conversational AI to the second conversational AI.

In a case where the type of content viewed by the user 11 has not been identified but the type of industry of the exhibition booth most frequently visited by the user 11 has been identified, and the type of industry of the exhibition booth most frequently visited by the user 11 is not the same as the type of user's industry registered in advance, the determination unit 604 may select a conversational AI 510 specialized in the identified industry and registered in the conversational AI DB. In a case where the type of industry of the exhibition booth most frequently visited by the user 11 is the same as the type of user's industry registered in advance, the determination unit 604 may not switch the conversational AIs 510.

In a case where the setting unit 502 has set a conversational AI 510 that provides general guidance instead of a conversational AI 510 specialized in a specific industry, the determination unit 604 determines to continue to use the conversational AI 510 that provides general guidance, regardless of whether or not the type of industry is the same. However, in a case where the type of content that the user 11 is interested in has been identified, the determination unit 604 switches from the current conversational AI 510 to a conversational AI 510 corresponding to the identified type of content that the user 11 is interested in.

For example, in a case where the setting unit 502 has set a conversational AI 510 suitable for providing general guidance and, in step S901, the extraction unit 603 has identified the type of content (e.g., component management software) the user 11 is interested in, the determination unit 604 selects a conversational AI 510 additionally trained or retrained and tuned to the specific specialized field such as component management software from among the conversational AIs 510 each having expertise in a specific industry and registered in the conversational AI DB. With this configuration, the determination unit 604 selects a conversational AI 510 that more directly introduces a product matching the interest of the user 11 than the set conversational AI 510 that provides general guidance. This configuration, therefore, helps avoid the risk of the user 11 terminating the dialogue before moving on to the step of introducing the product matching the interest of the user 11.

Referring back to FIG. 7, in a case where the determination unit 604 determines to switch the conversational AIs 510 in step S708, the information processing apparatus 100 performs processing in step S709.

In step S709, the switching unit 605 switches from the first conversational AI set by the setting unit 502 to the second conversational AI different from the first conversational AI, according to the result of the determination of the determination unit 604. For example, the determination unit 604 transmits a switching signal to the switching unit 605 and uploads information regarding the conversational AI 510 to be updated or overwritten or information regarding the conversational AI 510 that takes over the dialogue to the conversational AI 510. The information regarding the conversational AI 510 includes, for example, at least one of the 3DCG 511, the dialogue scenario 512, and the dialogue model 513 of the conversational AI 510.

The switching unit 605 switches the conversational AI that converses with the user 11 from the first conversational AI set by the setting unit 502 to the second conversational AI determined by the determination unit 604.

Examples of changing part of the configuration, namely, the 3DCG 511, the dialogue scenario 512, and the dialogue model 513, of the conversational AI 510 are described below.

### Changing Dialogue Scenario

As one example, it is assumed that the conversational AI 510 (first conversational AI) that conversed with the user 11 during the previous login is a conversational AI that has expertise in products relating to logistics solutions. Further, the action history of the user 11 in the metaverse this time indicates that the user 11 has visited a booth relating to products and services addressing pallet loss in logistics and listened to an explanation about such products and services. In this case, the switching control unit 503 extracts, as the dialogue scenario 512, a scenario that conducts a dialogue focusing on the products relating to the pallet loss prevention, and replaces the dialogue scenario 512 currently set in the first conversational AI with the extracted dialogue scenario 512. In this way, the switching control unit 503 switches from the first conversational AI to the second conversational AI in which the dialogue scenario 512 has been replaced and the 3DCG 511 and the dialogue model 513 remain unchanged.

For example, in response to the determination of switching the conversational AIs 510, the switching control unit 503 extracts the dialogue scenario 512 that introduces products addressing the pallet loss from the scenario DB 507 and overwrites the currently set dialogue scenario 512 with the extracted dialogue scenario 512. In this way, the switching control unit 503 replaces the dialogue scenario 512 set in the first conversational AI with the extracted dialogue scenario 512 to switch to the second conversational AI.

### Changing 3DCG

As one example, it is assumed that a male 3DCG 511 is set as the first conversational AI that provides general guidance. Further, the user 11 is a female and the visit history of the user 11 indicates that the user 11 has visited only female staff in booths or the user 11 has visited beauty-related booths. In this case, the switching control unit 503 may determine that the user 11 desires an explanation from a female, and thus switch to the second conversational AI in which the male 3DCG 511 has been replaced with a female 3DCG 511 and the dialogue scenario 512 and the dialogue model 513 remain unchanged.

The 3DCG 511 according to one or more embodiments of the present disclosure may include not only the appearance of the conversational AI 510 but also a model that controls the voice, reaction, or movement of the conversational AI 510. Examples of the reaction or movement include the magnitude of a gesture and the frequency of nodding.

Preferably, the dialogue model 513 according to one or more embodiments of the present disclosure includes a model that not only generates a dialogue but also controls the response timing or back-channeling such as interjections.

Referring back to FIG. 7, in step S710, the conversational AI 510 determined through the processing in steps S705 to S709 generates a 3DCG that depicts a conversational AI and an audio for the dialogue.

In steps S711 and S712, the communication unit 501 transmits the generated 3DCG and audio to the user terminal 10 via the host server 20.

In step S713, the user terminal 10 displays the conversational AI using the received 3DCG and audio. In step S714, a dialogue between the user terminal 10 and the information processing apparatus 100 starts.

### Second Embodiment

In a second embodiment, an example of a process of switching conversational AIs 510 based on the voice of the user 11 or the voice of an avatar of the user 11 in the metaverse space (hereinafter simply referred to as the “voice of the user 11”) is described.

### Conversational AI Switching Process

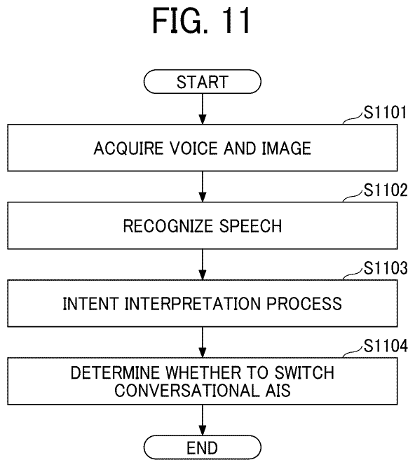

FIG. 10 is a sequence diagram illustrating an example of a conversational AI switching process according to the second embodiment. This process is an example of a process of the information processing apparatus 100 switching from the first conversational AI to the second conversational AI based on, for example, the voice of the user 11. It is assumed that at the start of the process in FIG. 10, the process in FIG. 7 has already been performed. The processing similar to the processing described in the first embodiment is not elaborated herein.

In step S1001, the user terminal 10 transmits a voice and an image of the user 11 to the host server 20. In step S1002, the host server 20 transmits the received voice and image to the information processing apparatus 100.

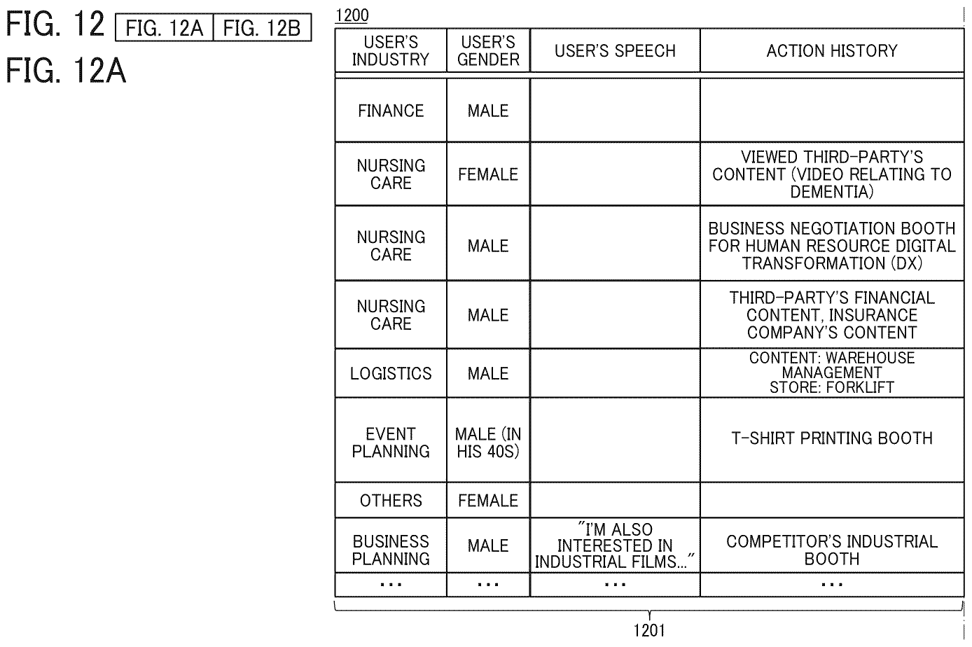

In step S1003, the information processing apparatus 100 performs a process of determining whether to switch conversational AIs 510, as illustrated in FIG. 11, for example.

FIG. 11 is a flowchart illustrating an example of the process of determining whether to switch the conversational AIs 510 according to the second embodiment. This process is an example of the process of the information processing apparatus 100 determining whether to switch the conversational AIs 510 in step S1003 of FIG. 10.

In step S1101, the communication unit 501 of the information processing apparatus 100 acquires (receives) the voice and image of the user 11. The voice and image of the user 11 are other examples of the predetermined information of the user 11.

In step S1102, the recognition unit 601 performs a speech recognition process on the voice of the user 11 to convert speech of the user 11 into text. The recognition unit 601 may also acquire non-verbal information of the user 11.

In step S1103, the interpretation unit 602 performs an intent interpretation process to interpret the intent of the speech of the user 11 based on, for example, the verbal information of the user 11 recognized by the recognition unit 601. The interpretation unit 602 may interpret the intent of the speech of the user 11, taking into account the non-verbal information of the user 11 recognized by the recognition unit 601.

In step S1104, the determination unit 604 determines whether to switch from the current conversational AI 510 (first conversational AI) to another conversational AI 510 (second conversational AI different from the first conversational AI). For example, in a case where the first conversational AI is unable to answer a technical question from the user 11, the determination unit 604 determines to switch from the first conversational AI to the second conversational AI specialized in the technical field relating to the question. Further, in a case where the user 11 has made a request regarding the first conversational AI, the determination unit 604 may determine to switch from the first conversational AI to the second conversational AI that matches the request received from the user 11.

In a case where there is no specific reason for switching to the second conversational AI, the determination unit 604 determines to continue to use the current conversational AI 510 (first conversational AI).

Referring back to FIG. 10, in a case where the determination unit 604 determines to switch the conversational AIs 510 in step S1003, the switching unit 605 performs processing of step S1004.

In step S1004, based on the result of the determination of the determination unit 604, the switching unit 605 switches from the current conversational AI 510 (first conversational AI) to another conversational AI 510 (second conversational AI) determined by the determination unit 604.

In step S1005, the conversational AI 510 determined through the processing in steps S1003 to S1004 generates a 3DCG that depicts a conversational AI and an audio for the dialogue.

In steps S1006 and S1007, the communication unit 501 transmits the generated 3DCG and audio to the user terminal 10 via the host server 20.

In step S1008, the user terminal 10 displays, using the received 3DCG and audio, the conversational AI 510 determined through the processing in steps S1003 to S1004 to continue the dialogue.

### Example Use Case

As one example, it is assumed that the information processing apparatus 100 selects a conversational AI 510 specialized in a camera device based on the process illustrated in FIG. 7 and the conversational AI 510 starts a dialogue with the user 11. Further, during the dialogue, for example, the information processing apparatus 100 receives a request from the user 11, “From an explanation given by a product-specific character (a character for camera products), I'm now interested in the difference between the industrial film of your company and the industrial films of the other companies for our new business.”

In this case, the information processing apparatus 100 switches the dialogue scenario 512 of the conversational AI 510 from a scenario for explaining camera products to a scenario for explaining industrial films. Further, the information processing apparatus 100 switches the 3DCG 511 of the conversational AI 510 from the character for camera products to a character for industrial components. The information processing apparatus 100 also changes the dialogue model 513 from “high tone and large reaction” to “low tone and small reaction.”

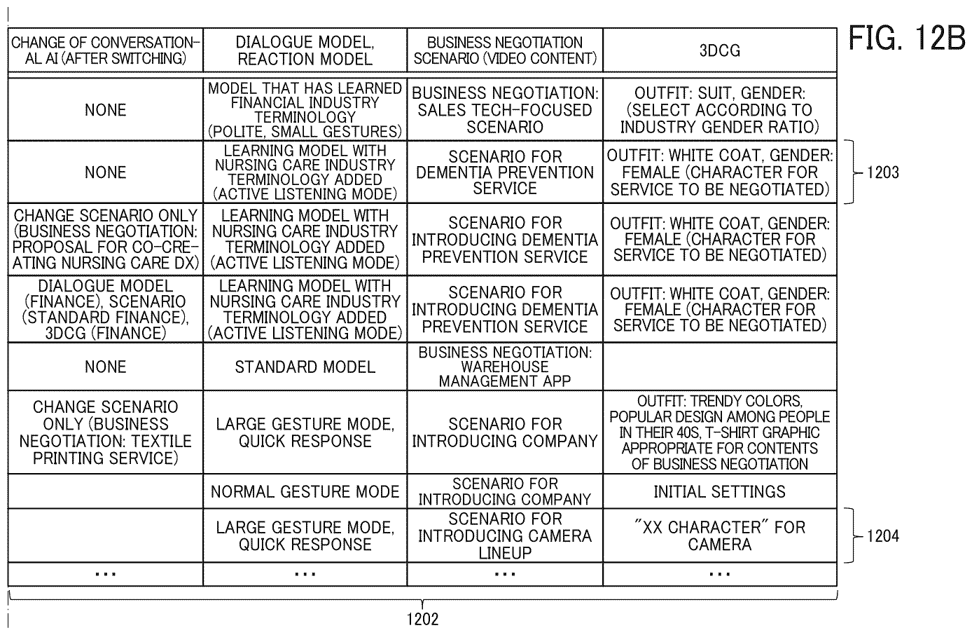

For example, the information processing apparatus 100 may store and manage the switching contents of conversational AIs 510 in switching information 1200 as illustrated in FIGS. 12A and 12B (FIG. 12).

FIGS. 12A and 12B (FIG. 12) are tables illustrating example switching information. In the example illustrated in FIG. 12, the switching information 1200 includes items of information such as “user's industry,” “user's gender,” “user's speech,” “action history,” “change of conversational AI,” “dialogue model, reaction model,” “business negotiation scenario,” and “3DCG.”

The items of information “user's industry,” “user's gender,” “user's speech,” and “action history” correspond to predetermined information 1201 of the user 11. The items of information “change of conversational AI,” “dialogue model, reaction model,” “business negotiation scenario,” and “3DCG” correspond to switching contents 1202 of the conversational AI 510 corresponding to the predetermined information 1201 of the user 11.

For example, in a case where the attribute information of the user 11 indicates that the user's industry is “nursing care” and the user's gender is “female,” and the action history indicates that the user 11 has “viewed third party's content (video relating to dementia),” the determination unit 604 determines to switch conversational AIs 510 in step S708 of FIG. 7 according to the switching contents 1202 of switching information 1203 in the second row of the switching information 1200.

In a case where the attribute information of the user 11 indicates that the user's industry is “business planning,” the user's gender is “male,” and the user's speech is “I'm also interested in industrial films . . . ,” the determination unit 604 determines to switch conversational AIs 510 in step S1003 of FIG. 10 according to the switching contents 1202 of switching information 1204 in the eighth row of the switching information 1200.

The switching information 1200 illustrated in FIG. 12 is merely an example. The determination unit 604 may perform the above-described determination by, for example, following a predetermined algorithm or using a trained machine learning model.

In a case where the switching unit 605 changes the 3DCG 511 when switching from the first conversational AI to the second conversational AI, it is desirable that before the switching, the first conversational AI performs some action or conducts a dialogue for the handover to the second conversational AI on the screen, for example. In this way, the handover is performed naturally. In this case, displaying the first conversational AI and the second conversational AI simultaneously on the user terminal 10 makes the handover more natural.

In a case where the information processing apparatus 100 receives voice data indicating the user's desire to proceed with the purchase of the explained product, the information processing apparatus 100 may, for example, display a purchase site on the screen of the user terminal 10 or perform an operation for connecting the user 11 to a real sales representative.

In a case where the information processing apparatus 100 does not narrow conversational AIs 510 down to a single conversational AI 510 that takes over the dialogue, the information processing apparatus 100 may switch from the current conversational AI 510 to a plurality of conversational AIs 510 (e.g., two conversational AIs 510) and display the plurality of conversational AIs 510 on the screen of the user terminal 10.

### Example Display Screens

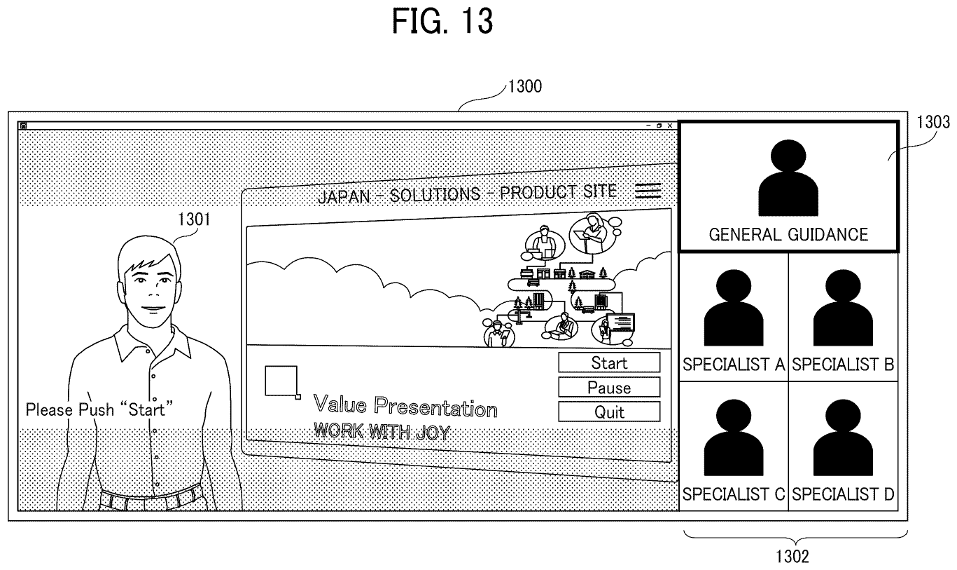

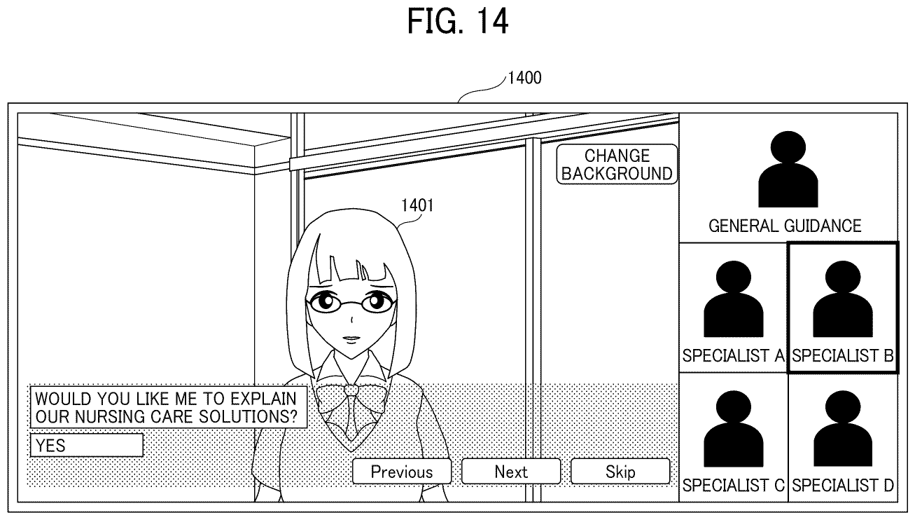

FIGS. 13 and 14 are views of example display screens. Specifically, FIG. 13 illustrates an example of a display screen 1300, which displays a first conversational AI 1301. FIG. 14 illustrates an example of a display screen 1400, which displays a second conversational AI 1401. The first conversational AI 1301 illustrated in FIG. 13 is a conversational AI for providing general guidance. The second conversational AI 1401 illustrated in FIG. 14 is a conversational AI specialized in nursing care solutions. In one example, the information processing apparatus 100 displays the display screen 1300 or 1400 on the user terminal 10 used by the user 11.

In the example illustrated in FIG. 13, the display screen 1300 displaying the first conversational AI 1301 displays a conversational AI list 1302, which lists available conversational AIs. The conversational AI list 1302 is displayed such that the user 11 recognizes the specialized field of the first conversational AI 1301 currently engaged in dialogue and the specialized fields of the other conversational AIs. In the example illustrated in FIG. 13, since the first conversational AI is a conversational AI for providing general guidance, “general guidance” 1303 is highlighted in the conversational AI list 1302.

In this state, for example, when the first conversational AI 1301 receives a question regarding nursing care solutions, the information processing apparatus 100 switches from the display screen 1300 to the display screen 1400, which displays the second conversational AI 1401 as illustrated in FIG. 14.

Preferably, the information processing apparatus 100 switches the conversational AIs in response to the user 11 informing the first conversational AI 1301, which provides general guidance, that the user 11 wishes to converse with the second conversational AI 1401.

Preferably, the information processing apparatus 100 switches the conversational AIs in response to the user 11 selecting the second conversational AI 1401 with which the user 11 wishes to converse from the conversational AI list 1302. In this way, when switching the conversational AIs, the information processing apparatus 100 (specifically, the switching unit 605) may present the conversational AI list 1302, which selectably presents conversational AIs as switching candidates, and switch from the current conversational AI to the conversational AI selected by the user 11.

The conversational AI list 1302 displays specialists A to D. The specialists A to D are not limited to conversational AIs specialized in the field of nursing care, but may be conversational AIs specialized in various fields such as logistics and image processing. Further, the conversational AI list 1302 may display a conversational AI that explains the quality and safety of a product in detail.

### Third Embodiment

The information processing apparatus 100 according to a third embodiment is applicable to a wide range of applications without being limited to a metaverse space. Hereinafter, an example of a process performed by the information processing apparatus 100 is described below without limiting to a specific application.

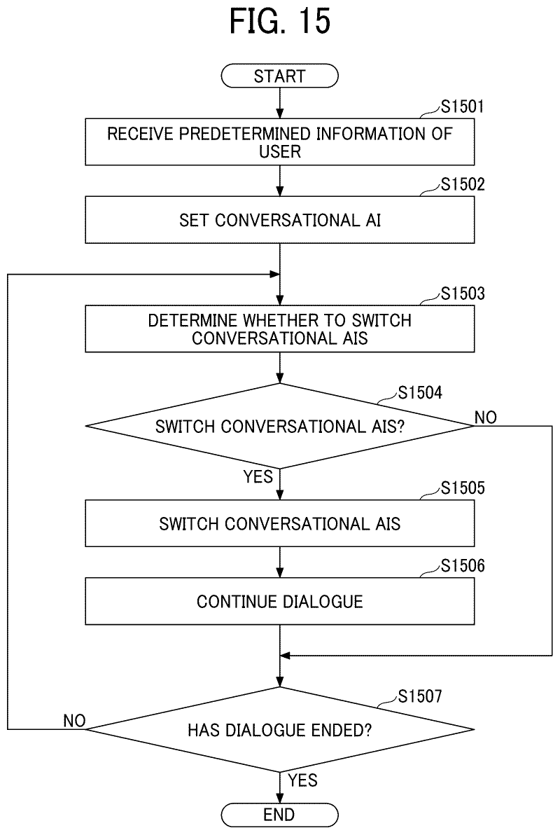

FIG. 15 is a flowchart illustrating an example of the process performed by the information processing apparatus 100 according to the third embodiment.

In step S1501, the communication unit 501 receives predetermined information of the user 11. The predetermined information of the user 11 may include action data of the user 11 collected by the user terminal 10 in real time, in addition to the information described in the first and second embodiments. For example, in a case where the user 11 is using a web browser, the user terminal 10 collects information such as browsing history or search history. In a case where the user 11 is using a smartphone application, the user terminal 10 collects information such as usage history of the application or position information.

In step S1502, the setting unit 502 analyzes the predetermined information of the user 11 received by the communication unit 501 and sets a conversational AI 510 (first conversational AI) optimal for the user 11 from among a plurality of conversational AIs 510 based on the analysis result.

Preferably, the setting unit 502 analyzes the predetermined information of the user 11, taking into account the current action pattern, past dialogue history, browsing history, search history, or selection history of the user 11. For example, in a case where the user 11 is searching for information about a product, the setting unit 502 may select a conversational AI 510 that responds to a question about the details of the product.

The setting unit 502 selects a conversational AI 510 that is most suitable for the needs of the user 11 or the current context by using, for example, a predetermined rule or a machine learning algorithm.

In step S1503, the determination unit 604 determines whether to switch the conversational AIs 510. For example, the determination unit 604 monitors the performance of the current conversational AI 510 in real time. In a case where the current conversational AI 510 does not provide an appropriate response to the question, or in a case where the user 11 expresses dissatisfaction with the current conversational AI 510, the determination unit 604 may step in and determine whether to switch the conversational AIs 510.

The determination unit 604 determines whether to switch the conversational AIs 510 based on a plurality of evaluation criteria. Examples of the evaluation criteria include the tone of the user 11 in the current dialogue, the response speed of the conversational AI 510, and the suitability of the conversational AI 510 in terms of the needs of the user 11. For example, in a case where the user 11 is asking a technical question but the current conversational AI is unable to answer the question, the determination unit 604 switches from the current conversational AI 510 to a conversational AI 510 having more expertise in the field relating to the question.

In a case where the determination unit 604 determines to switch the conversational AIs 510 in step S1504, the determination unit 604 causes the processing to proceed to step S1505. In a case where the determination unit 604 determines not to switch the conversational AIs 510 in step S1504, the determination unit 604 causes the processing to proceed to step S1506.

In step S1505, the switching unit 605 switches the conversational AIs 510 based on the result of the determination of the determination unit 604. The switching unit 605 switches the conversational AIs 510 seamlessly so that the dialogue between the user 11 and the conversational AI 510 selected this time flows without interruption.

For example, after switching, the conversational AI 510 selected this time takes over the dialogue history from the previous conversational AI 510 and smoothly continues the dialogue with the user 11. This allows the user 11 to receive support from the conversational AI 510 selected this time while maintaining the flow of the dialogue.

In step S1506, the conversational AI 510 selected this time takes over and continues the dialogue with the user 11. For example, the conversational AI 510 provides appropriate information or solves a problem according to the needs of the user 11.

Preferably, the conversational AI 510 collects feedback from the user 11 during the dialogue and uses the feedback to improve the quality of the dialogue. Examples of the feedback include feedback on the satisfaction of the user 11 and the performance of the conversational AI 510.

In step S1507, the information processing apparatus 100 determines whether or not the dialogue has ended. In a case where the dialogue has not ended, the information processing apparatus 100 causes the processing to return to step S1503. In a case where the dialogue has ended, the information processing apparatus 100 ends the process illustrated in FIG. 15.

Through the process illustrated in FIG. 15, the information processing apparatus 100 switches from the conversational AI 510 that has already been selected or executed to a more appropriate conversational AI 510 according to a change in the situation or requirement of the user 11. For example, even after switching from the first conversational AI to the second conversational AI, the information processing apparatus 100 may switch from the second conversational AI to a third conversational AI, the third conversational AI to a fourth conversational AI, and so on, through a similar process to the process illustrated in FIG. 15, to select a more appropriate conversational AI.

### Specific Use Cases

Use Case 1: Customer Support Scenario

### Overview of Scenario

The user 11 accesses the customer support of an online store and asks a question about a product. At this time, the first conversational AI responds to the initial question from the user 11.

### Determining Whether to Switch Conversational AIs

In a case where the first conversational AI is unable to answer a technical question from the user 11, the switching control unit 503 determines whether to switch from the first conversational AI to the second conversational AI (technical support AI) specialized in the field relating to the question.

### Switching Conversational AIs and Continuing Dialogue

The switching control unit 503 switches from the first conversational AI to the second conversational AI and the second conversational AI answers the technical question received from the user 11 to provide appropriate support.
Use Case 2: Personalized Marketing Scenario

### Overview of Scenario

The user 11 is using a shopping application and a conversational AI 510 for marketing is providing a personalized product recommendation based on the recent purchase history and browsing history of the user 11.

### Selecting Conversational AI and Determining Whether to Switch Conversational AIs

The conversational AI 510 for marketing analyzes the purchase history and browsing history of the user 11 and recommends a product suitable for the user 11. However, in a case where the user 11 requests detailed technical information about a specific product, the switching control unit 503 determines whether to switch from the conversational AI 510 for marketing to a conversational AI 510 that provides technical explanation.

### Switching Conversational AIs and Continuing Dialogue

The switching control unit 503 switches from the conversational AI 510 for marketing to the conversational AI 510 that provides technical explanation and the conversational AI 510 that provides technical explanation provides detailed technical information according to the request from the user 11.

According to one or more embodiments of the present disclosure, the conversational AI that has already been selected or executed for the user 11 is switched to a more appropriate conversational AI according to a change in the situation or a request from the user 11.

In one or more embodiments of the present disclosure, the information processing apparatus 100 provides a plurality of conversational AIs and appropriately selects a conversational AI or switches conversational AIs according to the diverse needs of the user 11. This improves the quality of the user experience while making the most of the expertise of each conversational AI.

Further, the seamless switching of the conversational AIs minimizes the interruption to the dialogue experience of the user 11. Moreover, utilizing the action history and the dialogue history of the user 11 helps provide more personalized services, thereby enhancing the system-wide efficiency and effectiveness.

One or more embodiments of the present disclosure provide an advanced technique for selecting a conversational AI and switching conversational AIs based on the action history of the user 11 and maximize the performance of the information processing apparatus 100. This technique is applicable to various fields such as customer support, personalized marketing, education, and entertainment.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The illustrated apparatuses are only illustrative of one of several computing environments for implementing the embodiments disclosed herein. For example, in some embodiments, the information processing apparatus 100 includes a plurality of computing devices, e.g., a server cluster, that are configured to communicate with each other over any type of communications link, including a network, a shared memory, etc. to collectively perform the processes disclosed herein.

Further, the illustrated elements of the information processing apparatus 100 can be combined into a single apparatus, or divided between a plurality of apparatuses in combinations. Further, at least part of the illustrated elements of the information processing apparatus 100 may be included in the user terminal 10 or the host server 20.

### ASPECTS

An information processing apparatus, an information processing system, an information processing method, and a program according to the following aspects are disclosed herein.

### Aspect 1

According to Aspect 1, an information processing apparatus provides a plurality of conversational artificial intelligences (AIs) that converses with a user via a user terminal, and includes a setting unit, a storage unit, a determination unit, and a switching unit. The setting unit sets a first conversational AI that converses with the user. The storage unit stores an action history of the user who converses with the first conversational AI. Based on the action history of the user, the determination unit determines whether to switch from the first conversational AI to a second conversational AI different from the first conversational AI during a dialogue between the first conversational AI and the user. The switching unit switches from the first conversational AI to the second conversational AI based on a result of the determination of the determination unit.

### Aspect 2

According to Aspect 2, in the information processing apparatus of Aspect 1, the determination unit determines whether to switch from the first conversational AI to the second conversational AI based on the action history acquired after setting the first conversational AI.

### Aspect 3

According to Aspect 3, in the information processing apparatus of Aspect 1, the switching unit selectably presents the second conversational AI as a switching candidate and switches from the first conversational AI to the second conversational AI selected by the user.

### Aspect 4

According to Aspect 4, in the information processing apparatus of Aspect 1, before the dialogue between the user and the first conversational AI that has been set by the setting unit starts, the determination unit determines whether to switch from the first conversational AI to the second conversational AI based on the action history of the user.

### Aspect 5

According to Aspect 5, in the information processing apparatus of Aspect 1, the action history includes a dialogue history.

### Aspect 6

According to Aspect 6, in the information processing apparatus of Aspect 1 or 5, the action history includes one or more pieces of information among a movement history, a browsing history, a search history, a selection history, and a purchase history.

### Aspect 7

According to Aspect 7, in the information processing apparatus of any of Aspects 1, 5, and 6, the action history includes one or more pieces of information among position information, device information, contents of information input in a form, an activity in social media, and an application in use.

### Aspect 8

According to Aspect 8, in the information processing apparatus of any of Aspects 1 to 7, the setting unit sets the first conversational AI based on the action history of the user.

### Aspect 9

According to Aspect 9, in the information processing apparatus of Aspect 8, in a case where the action history of the user is not available, the setting unit sets the first conversational AI based on attribute information of the user.

### Aspect 10

According to Aspect 10, in the information processing apparatus of Aspect 1 or 2, the switching unit further switches from the second conversational AI that converses with the user to a third conversational AI different from the second conversational AI based on the action history.

### Aspect 11

According to Aspect 11, in the information processing apparatus of Aspect 1 or 2, the switching unit switches from the first conversational AI that converses with the user to a plurality of conversational AIs based on the action history.

### Aspect 12

According to Aspect 12, in the information processing apparatus of Aspect 11, the plurality of conversational AIs includes the first conversational AI.

### Aspect 13

According to Aspect 13, in the information processing apparatus of Aspect 11, the plurality of conversational AIs includes the second conversational AI and a third conversational AI that are different from the first conversational AI.

### Aspect 14

According to Aspect 14, the information processing apparatus of Aspect 11 causes the user terminal to display the plurality of conversational AIs.

### Aspect 15

According to Aspect 15, in the information processing apparatus of any of Aspects 1 to 14, the first conversational AI is a conversational AI that provides general guidance.

### Aspect 16

According to Aspect 16, an information processing system includes a user terminal and an information processing apparatus that provides a plurality of conversational artificial intelligences (AIs) that converses with a user via the user terminal. The information processing apparatus includes a setting unit, a storage unit, a determination unit, and a switching unit. The setting unit sets a first conversational AI that converses with the user. The storage unit stores an action history of the user who converses with the first conversational AI. Based on the action history of the user, the determination unit determines whether to switch from the first conversational AI to a second conversational AI different from the first conversational AI during a dialogue between the first conversational AI and the user. The switching unit switches from the first conversational AI to the second conversational AI based on a result of the determination of the determination unit. The user terminal includes a communication unit and a display unit. The communication unit communicates with the information processing apparatus. The display unit displays a conversational AI provided by the information processing apparatus.

### Aspect 17

According to Aspect 17, an information processing method is performed by a computer that provides a plurality of conversational artificial intelligences (AIs) that converses with a user via a user terminal, and includes setting a first conversational AI that converses with the user via the user terminal, storing an action history of the user who converses with the first conversational AI, based on the action history of the user, determining whether to switch from the first conversational AI to a second conversational AI different from the first conversational AI during a dialogue between the first conversational AI and the user, and switching from the first conversational AI to the second conversational AI based on a result of the determining.

### Aspect 18

According to Aspect 18, a program causes a computer, which provides a plurality of conversational artificial intelligences (AIs) that converses with a user via a user terminal, to perform an information processing method. The an information processing method includes setting a first conversational AI that converses with the user via the user terminal, storing an action history of the user who converses with the first conversational AI, based on the action history of the user, determining whether to switch from the first conversational AI to a second conversational AI different from the first conversational AI during a dialogue between the first conversational AI and the user, and switching from the first conversational AI to the second conversational AI based on a result of the determining.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing apparatus comprising:
circuitry configured to set a first interactive artificial intelligence (AI) that interacts with a user via a user terminal; and
a memory that stores an action history of the user who interacts with the first interactive AI,
the circuitry being configured to:
based on the action history of the user, determine whether to switch from the first interactive AI to a second interactive AI different from the first interactive AI during an interaction between the first interactive AI and the user; and
switch from the first interactive AI to the second interactive AI based on a result of the determination.

2. The information processing apparatus according to claim 1, wherein the circuitry is configured to determine whether to switch from the first interactive AI to the second interactive AI based on the action history acquired after setting the first interactive AI.

3. The information processing apparatus according to claim 1, wherein the circuitry is configured to selectably present the second interactive AI as a switching candidate and switch from the first interactive AI to the second interactive AI selected by the user.

4. The information processing apparatus according to claim 1, wherein, before the interaction between the user and the first interactive AI that has been set starts, the circuitry is configured to determine whether to switch from the first interactive AI to the second interactive AI based on the action history of the user.

5. The information processing apparatus according to claim 1, wherein the action history includes an interaction history.

6. The information processing apparatus according to claim 1, wherein the action history includes one or more pieces of information among a movement history, a browsing history, a search history, a selection history, and a purchase history.

7. The information processing apparatus according to claim 1, wherein the action history includes one or more pieces of information among position information, device information, contents of information input in a form, an activity in social media, and an application in use.

8. The information processing apparatus according to claim 1, wherein the circuitry is configured to set the first interactive AI based on the action history of the user.

9. The information processing apparatus according to claim 8, wherein, in a case where the action history of the user is not available, the circuitry is configured to set the first interactive AI based on attribute information of the user.

10. The information processing apparatus according to claim 1, wherein the circuitry is configured to further switch from the second interactive AI that interacts with the user to a third interactive AI different from the second interactive AI based on the action history.

11. The information processing apparatus according to claim 1, wherein the circuitry is configured to switch from the first interactive AI to a plurality of interactive AIs including the second interactive AI based on the action history.

12. The information processing apparatus according to claim 11, wherein the plurality of interactive AIs includes the second interactive AI and a third interactive AI different from the first interactive AI.

13. The information processing apparatus according to claim 11, wherein the circuitry is configured to cause the user terminal to display the plurality of interactive AIs.

14. The information processing apparatus according to claim 1, wherein the first interactive AI is an interactive AI that provides general guidance.

15. An information processing system comprising:
the information processing apparatus according to claim 1; and
a user terminal to communicate with the information processing apparatus, the user terminal including a display that displays the first interactive AI or the second interactive AI.

16. An information processing method comprising:
setting a first interactive artificial intelligence (AI) that interacts with a user via a user terminal;
storing an action history of the user who interacts with the first interactive AI;
based on the action history of the user, determining whether to switch from the first interactive AI to a second interactive AI different from the first interactive AI during an interaction between the first interactive AI and the user; and
switching from the first interactive AI to the second interactive AI based on a result of the determining.

17. A non-transitory recording medium storing a plurality of instructions which, when executed by one or more processors, causes the one or more processors to perform an information processing method comprising:
setting a first interactive artificial intelligence (AI) that interacts with a user via a user terminal;
storing an action history of the user who interacts with the first interactive AI;
based on the action history of the user, determining whether to switch from the first interactive AI to a second interactive AI different from the first interactive AI during an interaction between the first interactive AI and the user; and
switching from the first interactive AI to the second interactive AI based on a result of the determining.
